(19) United States
(12) Patent Application Publication
(10) Pub. No.: US 2017/0337795 A1
(43) Pub. Date: Nov. 23, 2017

(54) MONITORING SYSTEM

(71) Applicant: Marcus Harrison, Gardena, CA (US)

(72) Inventor: Marcus Harrison, Gardena, CA (US)

(21) Appl. No.: 15/596,626

(22) Filed: May 16, 2017

Related U.S. Application Data
(60) Provisional application No. 62/337,733, filed on May 17, 2016.

(51) Int. Cl. G08B 21/02; G01S 19/42; G01S 19/16

(52) U.S. Cl. CPC G08B 21/0288; G08B 21/0283; G01S 19/16; G01S 19/42

(57) ABSTRACT

An improved monitoring system is a multifunctional monitoring system for children, women, disabled adults, medical, and military personnel, that combines a tracking device discretely embedded in the footwear of the user that is companioned with a smart phone application which will keep track of the wearer and upon command relay this information to police. The design intent is to quickly and efficiently track the location of a lost or abducted person and alert authorities of their location.

### CROSS-REFERENCE TO RELATED APPLICATION

The present application is related to and claims priority from prior provisional application Ser. No. 62/337,733, filed May 17, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of position monitoring systems and more specifically relates to improved monitoring system.

### 2. Description of the Related Art

Keeping one's children safe from harm is generally the highest concern for every parent. Whether it is openly discussing, calmly discouraging, or willfully forbidding such harmful acts as smoking, drug use, or unprotected sex, parents seek a myriad of ways to protect their kids in today's fast-paced world. While there are many potentially forces that can be harmful to children, parents feel confident that they have control over most of these. However, one of the greatest fears of every mother and father, and one which could render them completely helpless, is if their child were to become either lost or abducted. The Federal Bureau of Investigation estimates that more than 2,000 children are reported missing each day in the United States, adding up to nearly 750,000 children a year who run away from home or are the victims of a family or non-family abduction. Providing a visual to go along with these alarming statistics, bulletin boards in large shopping centers are virtually covered with missing children flyers and posters.

As diligent as parents are in keeping a constant eye on their little ones, children are very curious and energetic by nature. Walking through a mall, strolling along the fairway of an amusement park, or enjoying a day out at a city park provide many attractive distractions that may inspire kids to wander off and investigate. In a split second, a child can be lost in these crowded and busy places. One method of keeping children grouped and nearby that has become popular is the child leash. The leash provides some relief from the constant vigil of watching one's children. Similar in style to a dog leash, one end of this harness is tied to the parent's arm while the other end is secured around the child's wrist. While these leashes help parents keep active children close by, they can result in chafing of the skin, particularly if a rambunctious child is tethered to it. Additionally, many people see the child leash as inhumane and have little restraint in speaking out against the use of them. Many parents have turned to two-way radios and even cellular telephones as means of staying in contact. While these costly items work well for close communication with kids old enough to be responsible for carrying them and using them, they could prove too challenging and therefore impractical as a security measure for younger children. These items would also be rendered useless should a child fall victim to an abductor. There is a need for a technologically advanced and inconspicuous device for parents to use to maintain knowledge of the location of their children.

Various attempts have been made to solve the above-mentioned problems such as those found in U.S. Pub. No. 2013/0088386 to Sanjay Goswami; U.S. Pat. No. 6,819,258 to William W. Brown; and U.S. Pat. No. 6,788,200 to Mitchell W Jamel. This art is representative of position monitoring systems. None of the above inventions and patents, taken either singly or in combination, is seen to describe the invention as claimed.

Ideally, a position monitoring system should provide an inconspicuous method of tracking the location of one's children, and yet, would operate reliably and be manufactured at a modest expense. Thus, a need exists for a reliable improved monitoring system to avoid the above-mentioned problems.

### BRIEF SUMMARY OF THE INVENTION

In view of the foregoing disadvantages inherent in the known position monitoring system art, the present invention provides a novel improved monitoring system. The general purpose of the present invention, which will be described subsequently in greater detail, is to provide an inconspicuous method of tracking the location of one's children.

The improved monitoring system preferably comprises a smart phone that includes at least one computer circuit board with a computer application encoded upon the computer circuit board(s) that is adapted to track and provide information from a chosen tracking device located in at least one footwear member having an insole member. The tracking device has a transmitter member adapted to send electronic signals in the form of geographic information of the location of the footwear member having the tracking device, in a form that is able to be retrieved by a smart phone. The footwear member is adapted to be worn by a user so that the user can be tracked by a smart phone.

The power source is electronically connected to the transmitter member and the tracking device is attached to the insole member. The insole member is formed from two insole halves, and the tracking device is located in between the two insole halves. Global positioning satellite members are adapted to receive the electronic signals from the transmitter member and transmit the location of the footwear member to the smart phone. The tracking device may include an outer casing formed from a rigid plastic material having an interior volume that prevents water from entering the interior volume.

The smart phone further may include a liquid crystal diode screen adapted to project images of information of the tracking device. The smart phone further includes a series of menu prompts adapted to program the computer application with security codes unique to individual users.

The tracking device further includes a receiver member, a speaker member, and a microphone member all electronically connected to a power source, such that the tracking device is adapted to provide two-way communications.

The computer application further includes at least one electronic map encoded thereon and adapted to disclose where the tracking device is located in relation to roads, bodies of water, or other chosen landmarks. The computer application is further adapted to trace the path of the tracking device across the electronic map as the tracking device moves.

The two insole halves are glued together thereby encasing the tracking device therebetween. The footwear member further includes a lower portion, and an upper portion that is attached to the lower portion that together form an interior volume. The insole member is located within the interior volume, and the upper portion includes a releasable fastener thereon adapted to reduce the size of the interior volume and thereby adapting the footwear member to securely and releasably attach to the foot of a person to be tracked by the improved monitoring system. The power source may be formed as a rechargeable battery member.

The present invention holds significant improvements and serves as an improved monitoring system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved monitoring system, constructed and operative according to the teachings of the present invention.

FIG. 1 shows a perspective view illustrating an improved monitoring system according to an embodiment of the present invention.

FIG. 2 is a diagram illustrating the improved monitoring system according to an embodiment of the present invention of FIG. 1.

FIG. 3 is a top view illustrating the improved monitoring system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a position monitoring system and more particularly to a improved monitoring system as used to improve the inconspicuousness and convenience of tracking the location of one's children.

Generally speaking, an improved monitoring system is a multifunctional monitoring system for children, women, disabled adults, medical, and military personnel, that combines a tracking device discretely embedded in the footwear of the user that is companioned with a smart phone application which will keep track of the wearer and upon command relay this information to police. The design intent is to quickly and efficiently track the location of a lost or abducted person and alert authorities of their location.

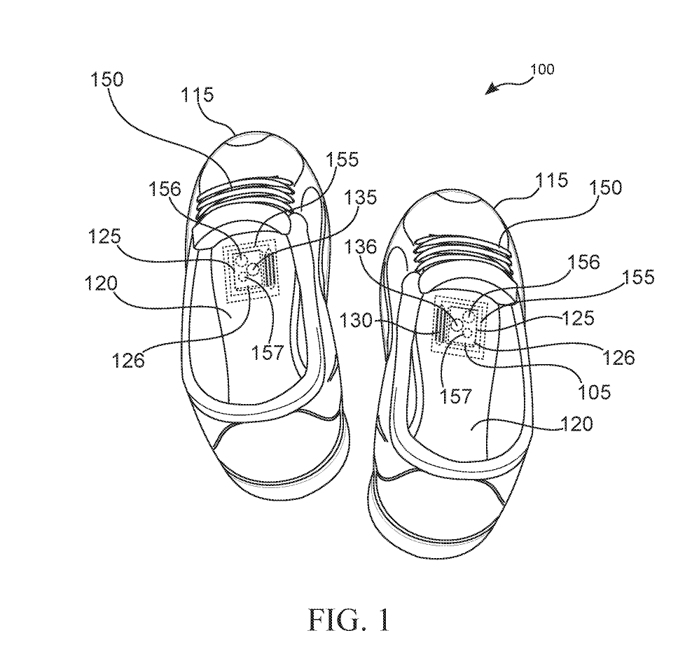

In greater detail now, referring to the drawings by numerals of reference there is shown in FIG. 1, a perspective view illustrating improved monitoring system 100 according to an embodiment of the present invention.

Improved monitoring system 100 would consist of footwear member 115 made from a vast array of styles and materials, including but not limited to sneakers, sandals, boots, dress shoes, and more. Improved monitoring system 100 would feature a specially designed electronic transmitter member 130, discreetly embedded between insole halves 121, that uses global positioning satellite members 140 to monitor the specific whereabouts of the wearer via the companion smart phone 165/computer application 160. Cleverly camouflaged within insole member 120 of footwear member 115, improved monitoring system 100 transmitter member 130 could be comprised of a high-tech computer chip. Having a durable, waterproof, plastic outer casing 126, this chip could be equipped with a tiny antenna which sends signals to the designated GPS satellite.

Improved monitoring system 100 preferably comprises smart phone 165 that includes at least one computer circuit board 105 with computer application 110 encoded upon computer circuit board 105 that is adapted to track and provide information from a chosen transmitter member 130 located in at least one footwear member 115 having insole member 120. Tracking device 125 has transmitter member 130 adapted to send electronic signals in the form of geographic information of the location of footwear member 115 having tracking device 125, in a form that is able to be retrieved by smart phone 165. Footwear member 115 is adapted to be worn by a user so that the user can be tracked by smart phone 165.

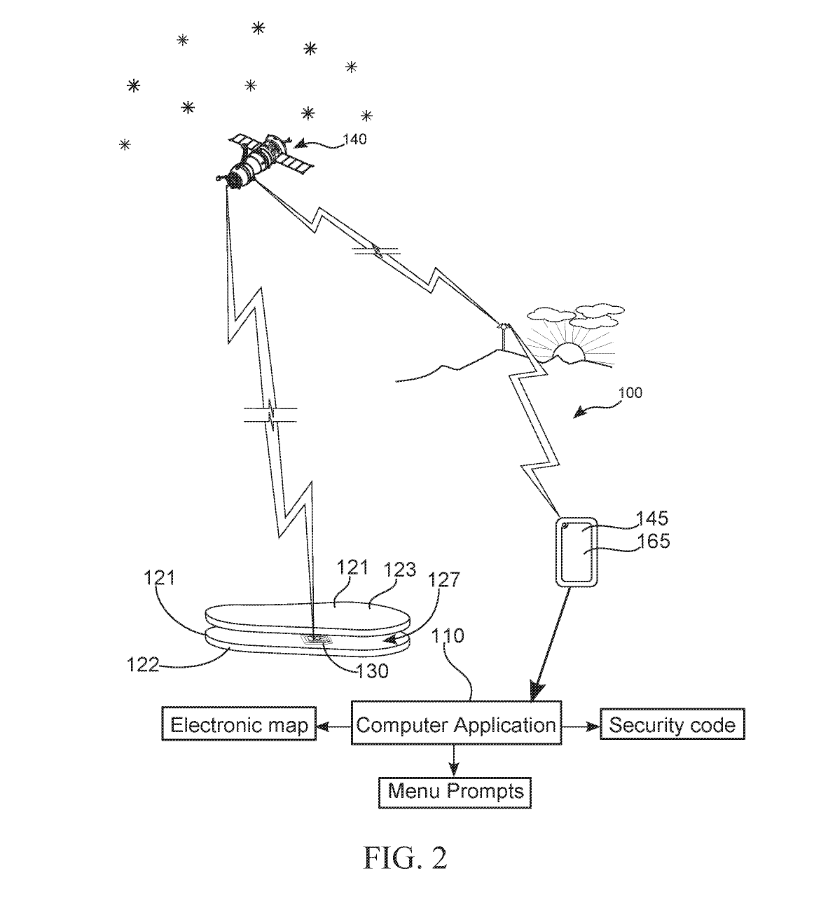

Referring now to FIG. 2, is a diagram illustrating improved monitoring system 100 according to an embodiment of the present invention of FIG. 1.

Power source 135 is electronically connected to transmitter member 130 and tracking device 125 is attached to insole member 120. Insole member 120 is formed from two insole halves 121, and tracking device 125 is located in between the two insole halves 121. Global positioning satellite members 140 are adapted to receive the electronic signals from transmitter member 130 and transmit the location of footwear member 115 to smart phone 165. Tracking device 125 may include outer casing 126 formed from a rigid plastic material having interior volume 127 that prevents water from entering interior volume 127.

The two insole halves 121 are glued together thereby encasing tracking device 125 therebetween. Footwear member 115 further includes lower portion 122, and upper portion 123 that is attached to lower portion 122 that together form interior volume 124. Insole member 120 is located within interior volume 124, and upper portion 123 includes releasable fastener 150 thereon adapted to reduce the size of interior volume 124 and thereby adapting the footwear member to securely and releasably attach to the foot of a person to be tracked by improved monitoring system 100. Power source 135 may be formed as a rechargeable battery member 136.

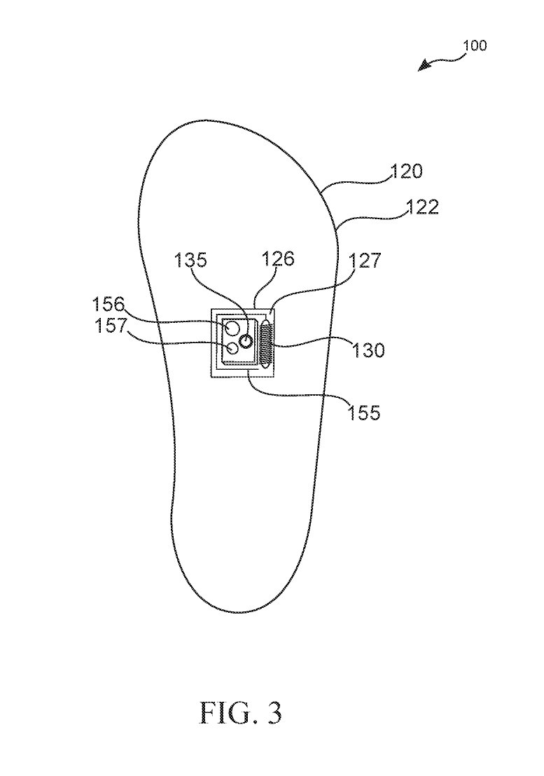

Referring now to FIG. 3, is a top view illustrating improved monitoring system 100 according to an embodiment of the present invention of FIG. 1.

Smart phone 165 further may include liquid crystal diode screen 145 adapted to project images of information of tracking device 125. Smart phone 165 further includes a series of menu prompts adapted to program computer application 110 with security codes unique to individual users tracking device 125 further includes receiver member 155, speaker member 156, and microphone member 157 all electronically connected to power source 135, such that tracking device 125 is adapted to provide two-way communications. Computer application 110 further includes at least one electronic map encoded thereon and adapted to disclose where tracking device 125 is located in relation to roads, bodies of water, or other chosen landmarks computer application 110 is further adapted to trace the path of tracking device 125 across the electronic map as tracking device 125 moves.

Improved monitoring system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. An improved monitoring system comprising:
a smart phone including:
at least one computer circuit board; and
a computer application;
wherein said computer application is encoded upon said at least one computer circuit board; and
wherein said application is adapted to track and provide information of a chosen tracking device; and
at least one footwear member including:
an insole member; and
a tracking device including:
a transmitter member adapted to send electronic signals that includes geographic information of said footwear member to be retrieved by said smart phone; and
a power source electronically connected to said transmitter member;
wherein said tracking device is attached to said insole member;
wherein said footwear member is adapted to be worn by a user such that said user can be tracked by said smart phone.

2. The improved monitoring system of claim 1, wherein said insole member is formed from two insole halves; and wherein said tracking device is located in between said two insole halves.

3. The improved monitoring system of claim 1, further comprising global positioning satellite members adapted to receive said electronic signals from said transmitter member and transmit the location of said at least one footwear member to said smart phone.

4. The improved monitoring system of claim 1, wherein said tracking device further includes an outer casing formed from a rigid plastic material.

5. The improved monitoring system of claim 4, wherein said outer casing forms an interior volume and prevents water from entering said interior volume.

6. The improved monitoring system of claim 1, wherein said smart phone further includes a liquid crystal diode screen adapted to project images of information of said tracking device.

7. The improved monitoring system of claim 1, wherein said smart phone further includes a series of menu prompts adapted to program the computer application with security codes unique to individual users.

8. The improved monitoring system of claim 1, wherein said tracking device further includes a receiver member; a speaker member; and a microphone member all electronically connected to said power source, such that said tracking device is adapted to provide two-way communications.

9. The improved monitoring system of claim 7, wherein said computer application further includes at least one electronic map encoded thereon and adapted to disclose where said tracking device is located in relation to roads, bodies of water, or other chosen landmarks.

10. The improved monitoring system of claim 9, wherein said computer application is further adapted to trace the path of said tracking device across said electronic map as said tracking device moves.

11. The improved monitoring system of claim 1, wherein said two insole halves are glued together thereby encasing said tracking device therebetween.

12. The improved monitoring system of claim 1, wherein said at least one footwear member further includes a lower portion and an upper portion attached to said lower portion and forming an interior volume; and wherein said insole member is located within said interior volume; and wherein said upper portion further includes a releasable fastener thereon adapted to reduce the size of said interior volume and thereby adapting said footwear member to securely and releasably attach to a foot of a person to be tracked by said improved monitoring system.

13. The improved monitoring system of claim 1, wherein said power source is formed as a battery member.

14. The improved monitoring system of claim 1, wherein said battery member is rechargeable.
